(19) United States
(12) Patent Application Publication
(10) Pub. No.: US 2014/0375505 A1
(43) Pub. Date: Dec. 25, 2014

(54) Positioning Using DTV Broadcast Signaling

(71) Applicant: TruePosition, Inc., Berwyn, PA (US)

(72) Inventors: Robert J Anderson, Phoenixville, PA (US); Rashidus S. Mia, Phoenixville, PA (US)

(21) Appl. No.: 13/925,487

(22) Filed: Jun. 24, 2013

(51) Int. Cl. G01S 5/14

(52) U.S. Cl. CPC G01S 5/145
USPC 342/464

(57) ABSTRACT

For indoor location of a wireless device, use of Digital Television (DTV) signals for receiver location allows for high yield, precise location estimates. The device location is determined based on pseudo-ranges between the device and a plurality of DTV transmitters. The pseudo-ranges are determined based on the known and a priori unknown portions of the DTV signals received by the device and monitor stations. A new Payload Correlation Procedure (payload=unknown DTV data segments) to locate a client device is employed, and a Field Correlation Procedure, which uses only known data segments of the DTV signal, may be used in conjunction with the Payload Correlation Procedure. This approach addresses the problem presented by the limited size of the radio communications link between the Location Server and Client versus the very large bandwidth of multiple DTV channels.

### TECHNICAL FIELD

The present invention relates generally to methods and apparatus for locating wireless devices, also called mobile stations (MS), such as those used in analog or digital cellular systems, personal communications systems (PCS), enhanced specialized mobile radios (ESMRs), and other types of wireless communications systems. More particularly, but not exclusively, the present invention relates to methods and apparatus for using Digital Television (DTV) broadcast signals for positioning.

### BACKGROUND

On Jun. 12, 1996, as a result of agreement made during the earlier Personal Communications System (PCS) spectrum auctions, the Federal Communications Commission (FCC) adopted a Report & Order that established performance goals for location accuracy and yield and set timetables for the identification of the wireless caller's phone number and geo-physical location when dialing the 911 emergency services telephone number. Under the FCC's Phase II rules, wireless carriers must provide geo-location information that includes longitude and latitude. In 1998 TruePosition, Inc. deployed the first wide-area wireless location system for wireless 911 in Harris County Texas. The TruePosition system was a network-based system, not requiring modifications to the mobile phone, using uplink (mobile-to-base station) Time-Difference-of-Arrival (TDOA).

By 2010, the vast majority of mobile subscribers in the United States had location-capability from either network-based systems or mobile-based E911 wireless location systems. TruePosition's system is the majority of network-based systems while the most common mobile-based wireless location system uses Global-Navigation-Satellite-Systems (GNSS) for location. (GNSS is a term that includes the United States Naystar GPS constellation, the Russian GLONASS, the Chinese Beidou/Compass system; and the proposed European Galileo and Indian Regional Navigational Satellite Systems.) Once wireless location systems had been widely deployed in support of emergency services location, carriers, software vendors, and subscribers began using mobile location capability for commercial purposes.

The first GNSS system, the NavStar Global Positioning System (GPS), revolutionized surveying, navigation, and real-time positioning. Initially devised in 1973 and fully operational since 1993, GPS is widely used for position location, navigation, survey, and time transfer. The GPS system is based on a constellation of 24 to 32 satellites in sub-synchronous 12 hour orbits. Each satellite carries a precise atomic clock and transmits a pseudo-noise signal, which can be precisely tracked to determine pseudo-range. By tracking 4 or more satellites, one can determine precise position in three dimensions in real time, world-wide. However in some radio environments, GNSS location receivers suffer from low yield due to poor satellite visibility. Because the GNSS signals are transmitted at relatively low power levels (less than 100 watts) and over great distances through the atmosphere, the received signal strength is relatively weak (on the order of −160 dBw as received by an omni-directional antenna). The weak GNSS satellite signal is marginally useful or not useful at all in the presence of blockage or inside a building due to additional attenuation. Location services require location capability across all environments—outdoor, indoor, and urban. High-value assets with installed locators and mobile location services customers are often indoors or in urban areas where GNSS signals are often unavailable.

One family of radio signals that is designed for deep in-building penetration is Digital Television (DTV). In December of 1996, the Advanced Television Systems Committee (ATSC) standard for DTV was adopted and by June 2009 was effectively the only allowed television broadcast standard in the United States. Over 1750 DTV stations exist in the continental United States. In the United States (and several other countries), the official DTV signal is the “ATSC signal”. The ATSC signal is described in ATSC document A/53E, entitled “Digital Television Standard” by the Advanced Television Systems Committee, Washington, D.C. (published 13 Sep. 2006); and document A/110, entitled “Synchronization Standard for Distributed Transmission,” also by the Advanced Television Systems Committee (published 14 Jul. 2004).

Using TV signals to generate a receiver location was taught in U.S. Pat. No. 4,555,707, “Television pulsed navigation system,” Nov. 26, 1985. Improvements to the art include the use of DTV signals for location, customization of the DTV signal, and the hybridization of DTV broadcast location with other network-based or mobile-based location technologies.

### SUMMARY

A goal of the present invention is to provide an improved method or system for locating wireless devices in for areas where navigation signals (e.g., GNSS signals) are severely attenuated or network-based receivers are unavailable. In the remainder of this application, we describe a wireless positioning system based on DTV broadcast signals for the precise location of mobile, nomadic and fixed devices equipped with wireless locator receivers. Such devices are referred to herein as Client terminals or Clients for short.

For indoor location, where navigation signals are often severely attenuated, use of Digital Television (DTV) signals for receiver location allows for high yield, precise location estimates. More specifically, the Client location is determined based on pseudo-ranges in respect to a plurality of DTV transmitters where the pseudo-ranges are determined based on the known and a priori unknown portions of the broadcast DTV signals received by the Client from the DTV transmitters and Monitor Stations. Exemplary methods for determining pseudo-ranges are disclosed in U.S. Pat. No. 6,861,984, Mar. 1, 2005, entitled “POSITION LOCATION USING BROADCAST DIGITAL TELEVISION SIGNALS”. (See col. 7 line 20 to col. 8 line 11, which describes a server-based approach, and col. 8 line 12 to col. 8 line 61, which describes a client-based approach. This patent is hereby incorporated by reference.)

Payload Correlation Procedure

In a presently preferred embodiment, the Payload Correlation Procedure (PCP), an inventive method for determining the position of a Client, comprises receiving at a local terminal and remote terminal a plurality of digital television (DTV) signals. Each DTV signal is broadcast from a DTV transmitter, and the local terminal determines a pseudo-range between the Client and a respective DTV transmitter using a priori unknown portions of the DTV signals. A position of the Client is determined based on the pseudo-ranges and geographic location of each of the DTV transmitters and the Monitor Station.

Parallel—PCP and FCP

In another embodiment, the Payload Correlation Procedure may be used concurrently with the Field Correlation Procedure (FCP), forming an inventive method for determining the position of a Client comprises receiving at a local terminal and remote terminal a plurality of digital television (DTV) signals. Each DTV signal is broadcast from a DTV transmitter, and the local terminal determines a pseudo-range between the Client and a respective DTV transmitter using both the known and a priori unknown portions of the DTV signals. Successful completion of an accurate location calculation using one technique will result in the other technique to be aborted.

Series—FCP then PCP

In another embodiment, the Payload Correlation Procedure may be used after the Field Correlation Procedure, forming an inventive method for determining the position of a Client comprises receiving at a local terminal and remote terminal a plurality of digital television (DTV) signals. Each DTV signal is broadcast from a DTV transmitter, and the local terminal determines a pseudo-range between the Client and a respective DTV transmitter using both the known and a priori unknown portions of the DTV signals. Successful completion of an accurate location calculation using the FCP will cause the PCP to be aborted.

In an illustrative embodiment described below, the Field Correlation Procedure used in parallel with or prior to the Payload Correlation Procedure comprises the following steps performed by the Monitor Station: collect channel data from a GNSS receiver and a plurality of local DTV transmitters according to a Field Capture Scheduler; receive specified channels and for each specified channel determine a set of Channel Parameters, and calculate a frequency offset of pilot channel (PFO) and a duration of frame versus ideal (FCRO); use a GNSS timing reference and correlation of known Field Synchronization segments to determine a time-of-arrival (TOA) and a time-of-transmission (TOT) of each received DTV signal, wherein the TOT is determined based on the location of the DTV transmitters; and package the Channel Parameters in a Channel Clock Parameters (CCP) message and forward the CCP message to a Location Server. The illustrative embodiment further comprises the step, performed by the Location Server, of storing the CCP message in a database indexed by channel, source monitor station and delivery time.

The illustrative embodiment may further comprise the following steps, performed cooperatively by the Location Server and Client, to compute an initial location: the Client requests a predicted channel list from the Location Server, wherein the predicted channel list contains a channel frequency and transmitter location; using a received channel list, the Client tunes a DTV receiver to collect DTV signals; the Client requests current Channel Parameter data from the Location Server for the DTV stations the Client can receive; the Location Server replies to the Client with an updated set of channel parameter data (CPP) as received from a Monitor Station; and using the Channel Parameter data, the Client computes a location estimate using TOA and TOT data.

In the illustrative embodiment, the predicted channel list may further comprise a cluster ID for a transmitter that is part of a cluster of transmitters located in close proximity. In addition, the Location Server may further perform the steps of refining the location estimate using at least one of a cell-ID, cell-ID with ranging, or Enhanced Cell-ID location technique; and/or evaluating the location estimate to determine if an accuracy threshold has been reached, and if not then applying a Field Correlation Procedure to derive an improved location estimate.

A preferred implementation of the Payload Correlation Procedure may include the following steps: the Client selecting a set of DTV channels to be used in the Payload Correlation Procedure; the Client sending individual requests for payload on a per channel basis to the Location Server, and the Location Server forwarding each request to the Monitor Station for a remote capture of Payload data; the Monitor Station either recovering a most recent payload for the requested channel or tuning its DTV receiver to collect a new Payload based on a request collection time period; the Client capturing a local copy of the Payload Field for use as a Reference; the Monitor Station sending a Channel Field Payload to the Location Server, and the Location Server forwarding the Channel Field Payload to the Client; the Client correlating the Channel Field Payload and Reference over the timespan of the capture interval and computing the time-difference-of-arrival (TDOA) and frequency-difference-of-arrival (FDOA); and using the computed initial location estimate, TOA and TOT data, original channel list, and the TDOA data from the Field Payload correlation, the Location Server computing an improved location estimate and error estimate. (Note that, in the illustrative embodiment, TOA and TOT are only used if a FCP/PCP location was computed. If the PCP is used alone, then TOT and TOA are not computed.)

The set of DTV channels selected may advantageously be based on one or more of the following factors: (a) a set DTV channels with a signal-to-noise ratio (SNR) higher than a threshold value are selected; (b) DTV channels for which no TOA can be established using the correlation of the signal with known components are selected; (c) DTV channels are selected on the basis of transmitter location and geographic diversity, to minimize effects of geometric-dilution-of-precision.

The present invention also encompasses inventive systems, computer readable media, and Client terminals for carrying out the inventive methods. Other features of the present invention are described below.

### BRIEF DESCRIPTION OF THE DRAWINGS

The foregoing summary, as well as the following detailed description, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 illustrates positioning of a receiver in a radio broadcast system.

FIG. 2 illustrates positioning of a receiver in a radio broadcast system enhanced with Portable Pseudo-television Transmitters and a Monitor Interconnection Facility.

FIG. 3A shows an illustrative ATSC Frame.

FIG. 3B shows the parts of an ATSC Field Synchronization Message.

FIG. 3C shows the parts of an ATSC Data Segment.

FIG. 4 illustrates the background collection of broadcast timing information.

FIG. 5 illustrates a Client-based Payload Correlation procedure for precise location.

FIG. 6 illustrates an alternative Server-based Payload Correlation procedure.

FIG. 7 shows a hybrid Field Correlation procedure using the duplex wireless communications radio signal

FIG. 8 illustrates a procedure for determining the initial location of a Client device as part of a multi-pass location technique

FIG. 9 schematically depicts the structure of a monitor station.

FIG. 10 schematically depicts the structure of a Client device.

FIG. 11 schematically illustrates the computation of a location estimate using both the Auxiliary Field Correlation and Payload Correlation procedures.

FIG. 12 shows the possible signal extraction points in the DTV receiver

FIG. 13 depicts the incremental correlation of signals to decrease location latency

FIG. 14 graphically summarizes the use of the Field Correlation and Payload Correlation procedures for location.

### DETAILED DESCRIPTION OF ILLUSTRATIVE EMBODIMENTS

We will now describe illustrative embodiments of the present invention. First, we provide a detailed overview of the problem and then a more detailed description of our solutions.

### Overview

For the Time-Difference-of-Arrival (TDOA) location technique, which includes the reception of DTV signals at a locator receiver, the Cramer-Rao Lower Bound represents the minimum achievable variation in TDOA measurement and thus the ultimate achievable precision of the downlink-TDOA system (where multiple broadcasts from geographically distributed transmitters are received by a locator receiver). The accuracy of any individual location estimate will vary with radio conditions unique to that location, including the multi-path environment and geometric dilution of precision from the geometry of the mobile device in respect to the transmitters.

Theoretically, the precision of a downlink-TDOA technology is limited by several practical factors such as integration time, signal-to-noise ratio (SNR) at each receiver site, as well as the bandwidth of the transmitted signal. The Cramer-Rao bound illustrates this dependence. The bound can be approximated for any pair of transmitters (downlink TDOA requires a minimum of three received transmissions) as:

$${TDOA}_{CRLB} = \frac{1}{{( 1.5 )}^{1 / 2} π {B}^{3 / 2} {T}^{1 / 2} {SNR}^{1 / 2}}$$

where B is the bandwidth of the signal, T is the integration time and SNR is the smaller SNR of the two receiver sites (i.e., the monitor and the Client). From the theoretical analysis, controllable factors for improving the location performance of a TDOA system are bandwidth, integration time and signal strength. Since the bandwidth of the DTV system is fixed and the signal strength is whatever can be obtained from the broadcast transmission, then only integration time can be improved.

Different location applications have different location services requirements such as accuracy and time-to-location. For instance, in respect to accuracy, the United States E9-1-1 Phase 2 mandate requires that location error be less than 150 meters for 95 percent of the calls and 50 meters for 67 percent of the calls.

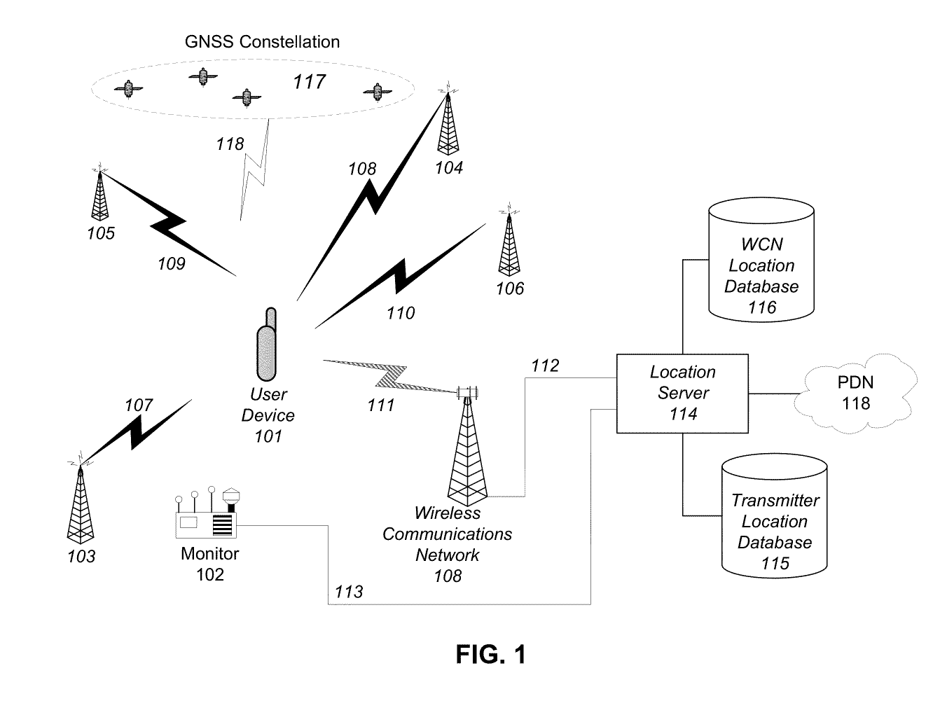

### FIG. 1

FIG. 1 illustrates a wireless location system (WLS); including the WLS network elements and ancillary broadcast and wireless communications networks in which the locator receiver functions. The User Terminal or Client 101 is the wireless device that is equipped with the DTV locator receiver. The Client 101 also possesses the ability to communicate over radio signaling 111 with a wireless communications network (WCN) 108. The Client may also have a GNSS receiver installed.

The Monitor 102 is a specialized DTV receiver used to characterize signals within its geographical region and report to one or more Location Servers 114. The Monitor 102 may be a single channel or multi-channel DTV receiver. The Monitor 102 receives the broadcasts from geographically local DTV transmitters, or stations, and creates a channel report for each station 103 104 105 106. The channel reports include timing parameters (time of arrival (TOA) and Time of Transmission (TOT)) referenced to each transmitter antenna for each received DTV channel, a payload snapshot, and optionally GNSS data. The Monitor 102 is equipped with a GNSS receiver for system time generation allowing an absolute time-of-arrival of the ATSC signal frame and fields to be computed. The GNSS clock is also used to synchronize all wireless location system network elements. The Monitor 102 sends channel reports to the Location Server 114 via a generic datalink 113 on a continuous, periodic or as-requested basis. In some deployments, the Monitor Station 102 and Location Server 114 may share location and circuitry.

The Location Server 114 acts to receive channel reports from one or more Monitor(s) 102 and reconcile them into a master channel list. For cases when the client is set as the local terminal and for Client-based position calculation, the Location Server 114 provides, from the master list, requesting Clients a Transmitter list, Transmitter positions, channel measurements and the payload snapshot based on the coarse, initial Client position, where the coarse Client position may be provided, e.g., by the Location Area Code (LAC) or Cell Identity (CI) of the serving cell tower of the WCN 108. Using data from the broadcast radio signals, the client may collect and forward wireless communications network parameters such as cell-identity (CI, CID), access-point service set identifier (SSID), location area code (LAC), as well as power and timing parameters (e.g. Received Signal Strength Indicator (RSSI) and Reference Signal Received Power (RSRP), timing advance, one-way-serving-delay, Time of Flight (ToF) or Round-Trip-Time (RTT)).

For Server-based position calculation, where the server is the remote terminal, the Location Server 114 collects the coarse Client position and then tasks the Client with a transmitter list. From the Client 101, the Location Server 114 obtains a transmitter list, channel measurements, and the payload snapshot via the WCN 108. The Location Server has access to a DTV transmission antenna locations database 115 and a WCN transceiver location database 116. WCN transceiver location database 116 may be used to calculate a rough location for the Client 101 and then a subset of DTV transmission antenna locations database 115 is sent to the Client 101 to allow determination of the Client-based location estimate

The DTV network comprises independent DTV broadcast transmit antenna 103 104 105 106. The DTV network provides a continuous, low frequency (50-750 MHz), high strength (up to 100,000 Watts effective radiated power (ERP)), high bandwidth (6 MHz) signal 107 108 109 110 with preset pilot, framing and synchronization signals. Generally, radio signaling 107 108 109 110 from each transmitter 103 104 105 106 is unsynchronized. In the United States, the DTV signal standard is the ATSC 1.0 standard with planned 2.0 and 3.0 releases currently in drafting. Although the term broadcast is used for the DTV RF signaling 107 108 109 110, use of directional antennae is not precluded.

The wireless communications network (WCN) 108 is a cellular or wide-area-data-network that comprises geographically separated transceivers (e.g., cellular base stations, wireless access points); the WCN 108 serves to provide 2-way radio 111 and wired connectivity 112 between the Client 101 and the Location Server 114.

The GNSS constellation 117 sends its navigation radio signals 118 providing a high-accuracy distributed clock for time-stamping of received DTV signals 107 108 109 110. The GNSS signals 118 also allow all monitors 102 to be synchronized. The monitor(s) may also self-locate using the GNSS signals 118 and collected GNSS signal information may be used to construct assistance data either at the monitor 102 or at the Location Server 114 for use by the Client 101. In installations where GNSS signals are blocked, or as a deployment option, other timing mechanisms may be used.

The Public Data Network (PDN) 118 provides data connectivity from the Location Server 114 to the rest of the world. Location data on the Client 101 may be requested and/or delivered via the PDN 118. The PDN 118 also allows access for Operation, Administration, Maintenance, Monitoring, Provisioning and Troubleshooting (OAMMPT) of the wireless location system via the Location Server 114.

### Positioning Using DTV Broadcast Signaling

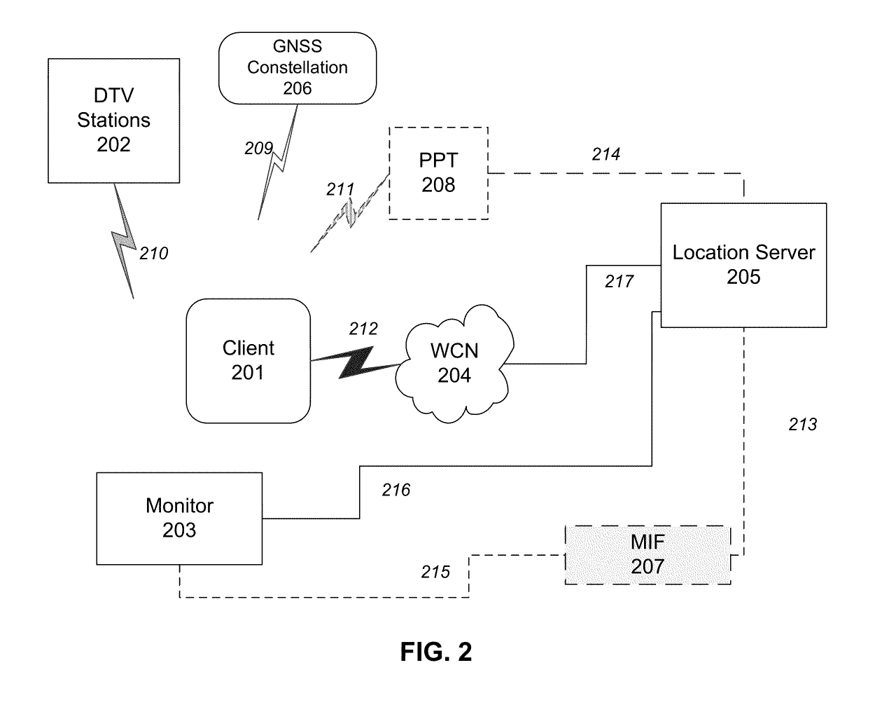

### FIG. 2

FIG. 2 depicts functional and optional nodes of the inventive wireless location system. The Client 201 receives DTV broadcasts to establish and maintain timing and frequency references. The Client 201 allows either Client-based or server-based location using the local broadcasts 210 from the location DTV stations with information delivered from the Location Server 205 over the WCN 204. Optionally, the Client may also collect navigation and timing signal broadcasts 209 from the GNSS constellation 206.

The DTV stations 202 provide continuous, stable radio broadcast 210 at high power, high bandwidth and low frequency. The Client 201 and Monitor 203 receive the radio broadcast 210 and use it for location and timing.

The Monitor Station 203 receives DTV signals 210 and GNSS signals 209, and analyses the DTV signals 210 to determine signal characteristics such as received power, timing stability, SNR, and frequency stability. The signals 210 are used by the monitor to provide the Location Server 205 with time of arrival and time of transmissions. The Monitor Station 203 can also provide segment payload data either as a data stream or on a request/response basis. The Monitor Station 203 may report to one or more Location Servers 205. U.S. Pat. No. 7,471,244, “Monitor units for television signals,” Dec. 30, 2008, contains additional detail on a representative implementation of a Monitor Station 203.

The Wireless Communications Network 204 provides interconnection via wireless communications radio signal 212 as well as switching and routing between the Location Server 205 and the Client 201. The WCN 204 can also provide, via its downlink beacons, a rough position when the cell identifier is linked to a base station whose geographic position is stored by the Location Server 205.

The Location Server 205 is the repository for cellular base station and DTV broadcast sites. The Location Server 205 provides coarse timing to the Client and can forward GNSS assistance data to GNSS-equipped Clients 201 developed by the Monitor 203.

The GNSS constellation 206 provides the GNSS signals 209 that are nominally used by the Monitor Station for timing. The GNSS signals 209 may also be used by a GNSS receiver-equipped Client for self-location (either solely, with assistance, or for hybridization with the DTV location estimate) and timing. In installations where GNSS signals are blocked or as a deployment option, other timing mechanisms may be used.

The Monitor Interconnection Facility (MIF) 207 is an optional system component designed to prevent border areas between Location Servers 205. The MIF 207 aggregates information from multiple Monitor Stations 203 and routes the information to Location Server(s) as needed to prevent border areas.

The portable pseudo-television transmitter (PPT) 208 is designed to supplement the existing DTV signaling 210 by providing additional DTV broadcast transmissions 211 in geographic areas with poor DTV coverage. U.S. Pat. No. 6,839,024, “Position determination using portable pseudo-television broadcast transmitters,” Jan. 4, 2005, contains additional details on a representative implementation of a PPT 208.

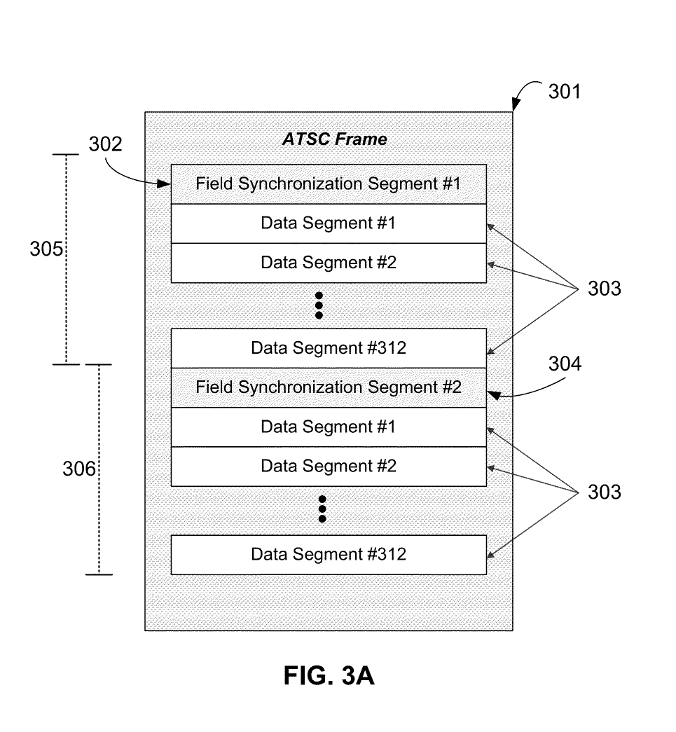

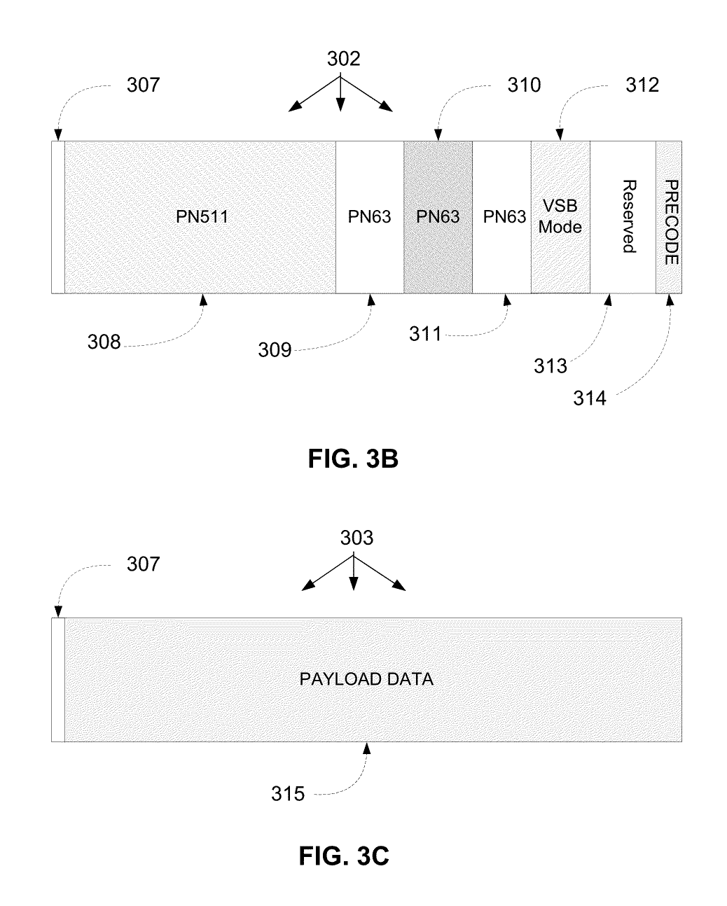

### FIG. 3A

The ATSC signal uses 8-ary Vestigial Sideband Modulation (8VSB). The symbol rate of the ATSC signal is 10.762237 MHz, which is derived from a 27.000000 MHz clock. The structure of the ATSC Frame 301 is illustrated in FIG. 3A.

The ATSC Frame 301 consists of a total of 626 segments, each with 832 symbols, for a total of 520832 symbols. There are two Field Synchronization Segments 302 304 in each frame 301. Following each Field Synchronization Segment 302 304 are 312 data segments 303. Thus, as shown, Field Synchronization Segment #1 and Data Segments #1 through #312 make up a first part 305 of the ATSC Frame 301. Similarly, Field Synchronization Segment #2 and Data Segments #1 through #312 make up a second part 306 of the ATSC Frame 301.

### FIG. 3B

The structure of the Field Synchronization Segments 302 304 is illustrated in FIG. 3B. Each Field Synchronization Segment and Data Segment 302 303 304 begins with 4 symbols that are used for synchronization purposes 307. The Field Synchronization Segments 302 304 carry known pseudo-random data in the PN511 grouping 308 and three PN63 groups 309 310 311. The level_ID field 312 is used in ATSC to indicate vestigial side band (VSB) and the data rate. The precode field 314 contains data bits from the previous segment, and the reserved field 313 is for future use. The two Field Synchronization Segments 302 304 in a frame 301 differ only to the extent that the middle set of 63 symbols 310 are inverted in the second Field Synchronization Segment 304.

### FIG. 3C

The structure of the ATSC data segment 303 is illustrated in FIG. 3C. The first four symbols 307 of data segment 303 (which are −1, 1, 1, −1) are used for segment synchronization. The other field 315 (consisting of 828 symbols) carry data. The carried data, the payload, is nominally MPEG video in a DTV broadcast. The contents of the payload are not known to the receiver a priori.

A technique, the Field Correlation Procedure (FCP), for determining a location via determination of time-of-arrival using correlation of known DTV signal components is disclosed by commonly-owned U.S. Pat. No. 6,861,984, “Position location using broadcast digital television signals, Mar. 1, 2005, which is hereby incorporated by reference in its entirety. The Payload Correlation Procedure (PCP) uses correlation of time-matched segments of baseband DTV signal (a priori unknown) for DTV-based receiver location, which provides additional processing gain and receiver sensitivity that enables location in challenging radio environments. Hybrids of the FCP and PCP may be used to reduce the latency and improve the accuracy of a location calculation using both the known and a priori unknown portions of DTV broadcast signals.

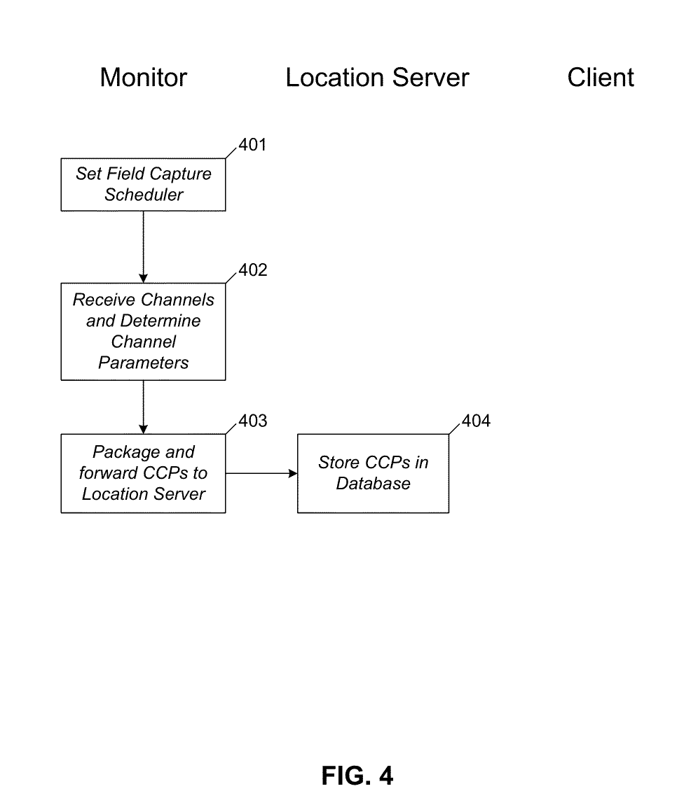

FIGS. 4, 5 and 6 are discussed next as we further describe an exemplary process for positioning of a receiver in an area served by DTV stations and a wireless communications network. In each location attempt, there is a local and remote terminal. The local terminal collects DTV transmission data locally while the Remote terminal simultaneously collects DTV data and then transmits its collected data to the local terminal for correlation. The correlation results are then used in a location calculation that can be performed at either the local or remote terminal. Either the Location Server (with its serving Monitor(s)) or the Client may be set for any location attempt as either the remote or local terminal in regards to signal collection and/or location computation. In some cases, the selection of remote and local terminals may be apportioned to the Location Server and Client for each individual DTV channel in the channel list for a particular location attempt.

### FIG. 4

FIG. 4 illustrates the continuous background operation of the Monitor Station in the collection of channel data from the GNSS receiver and local DTV stations. The Monitor is set to receive the local DTV channels either manually or via scanning mechanism. A Field Capture Scheduler can then be set 401. The Field Capture Scheduler is used to tune the DTV receiver at the set time, for the set period, and to record portions of the DTV into a temporary cache.

The Monitor then proceeds to receive all specified channels and for each channel determines a set of Channel Parameters 402. The Monitor calculates the frequency offset of pilot channel (PFO), the duration of frame versus ideal (FCRO) and received power level. Using the GNSS timing reference and the correlation of the known Field Synchronization segments, the Time-of-Arrival (TOA) of the radio signal is found. The resulting TOA is then time-stamped using the GNSS clock time. Using database information on the location of the DTV transmitters, the Time-of-Transmission (TOT) for each DTV signal is calculated.

The developed channel information is then packaged in a Channel Clock Parameters (CCP) message and forwarded to the Location Server 403. At the Location Server, the CCP messages are stored in a database indexed by channel, source monitor and delivery time. The resultant DTV channel measurements database is consulted for each PCP, FCP or PCP/FCP location attempt to develop the initial channel list.

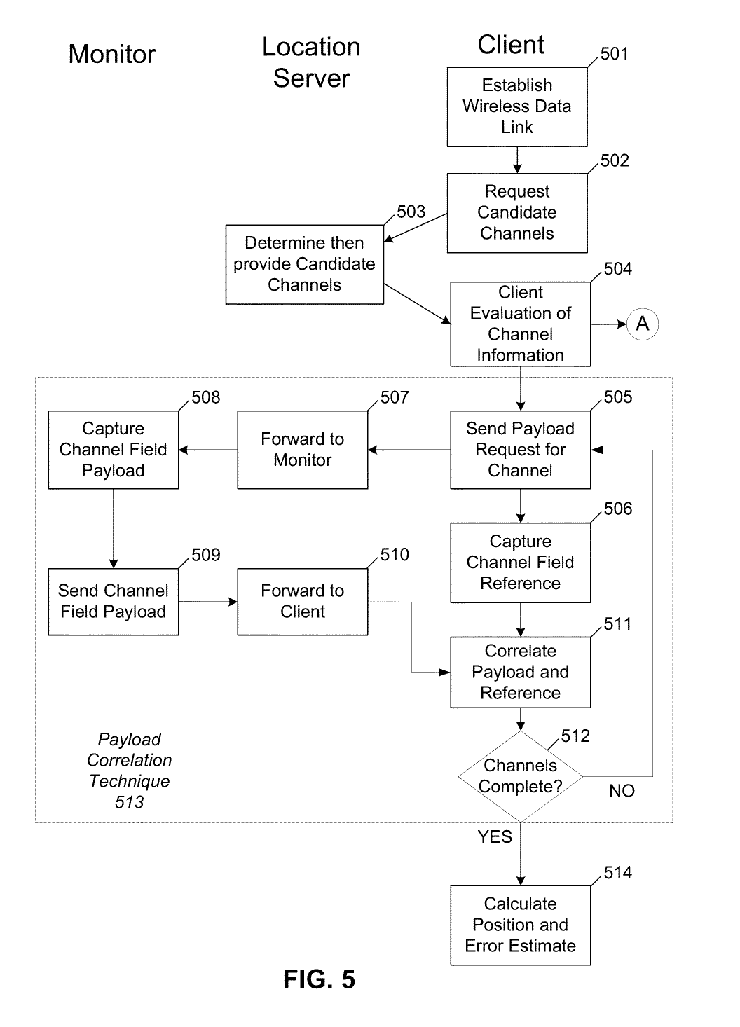

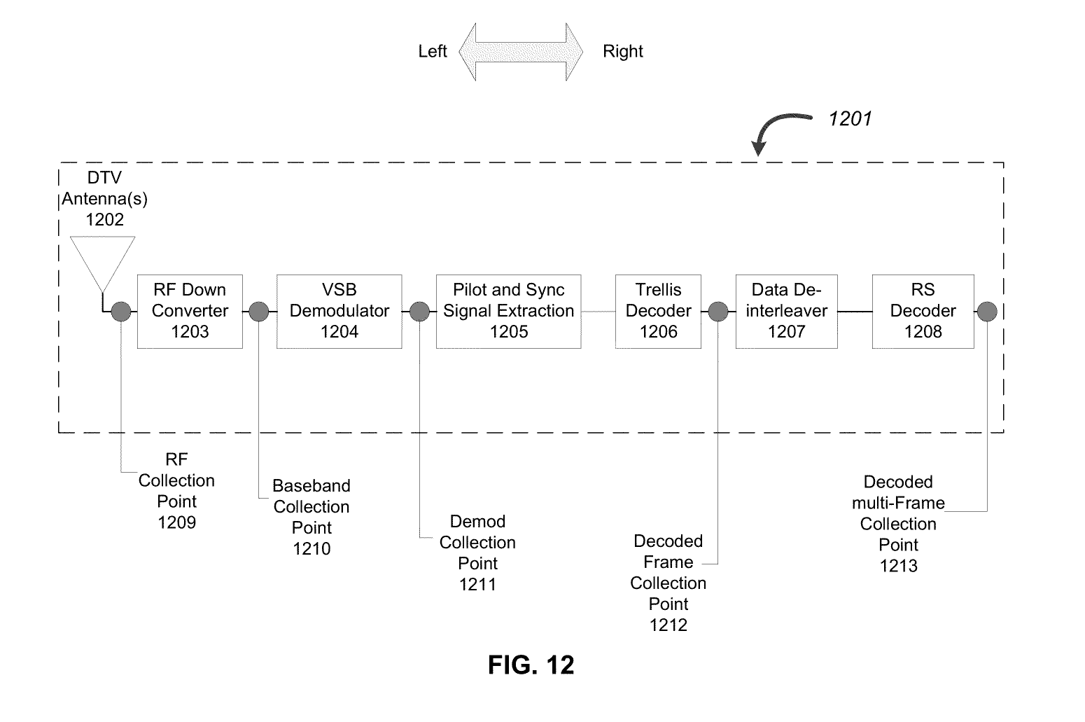

FIGS. 5, 6 and 7 are used to illustrate the Payload Correlation Procedure (PCP) for DTV receiver location. The PCP may be used alone or as part of a hybrid and/or multi-pass DTV receiver location technique. Payloads may be compressed and encoded using a lossless encoder, or the payload extraction point (see FIG. 12) selected to minimize the payload size.

### FIG. 5—Client-Based Payload Correlation Implementation

FIG. 5 illustrates an implementation of the client-initiated, client-based (that is the client is the Local site) Payload Correlation Procedure. Once the Payload Correlation Procedure has been elected and the wireless connection established 501, the Client requests an initial candidate list of DTV transmitters 502 from the Location Server. The Location Server, using the location information derived from the wireless communications system then determines an initial candidate channel list (DTV ID, Frequency, Latitude, Longitude, Antenna Altitude, Predicted Receive Power) with is provided back to the client 503.

The location server's initial list of DTV transmitters 503 based on the location information or rough location sent by the client. If a sufficiently low-latency, high bandwidth wireless communications exists between the Client and Location Server, the channel list may not be downselected or the downselection may be adjusted to remove few channels by allowing a lower SNR or redundancy in clustered transmitters. While nominally a Location Server function, downselection may occur at the client if DTV transmitter radio broadcast and location information was previously downloaded to the device (such downloads could occur e.g. when the client is first activated, when a new wireless service area is detected, or according to a schedule).

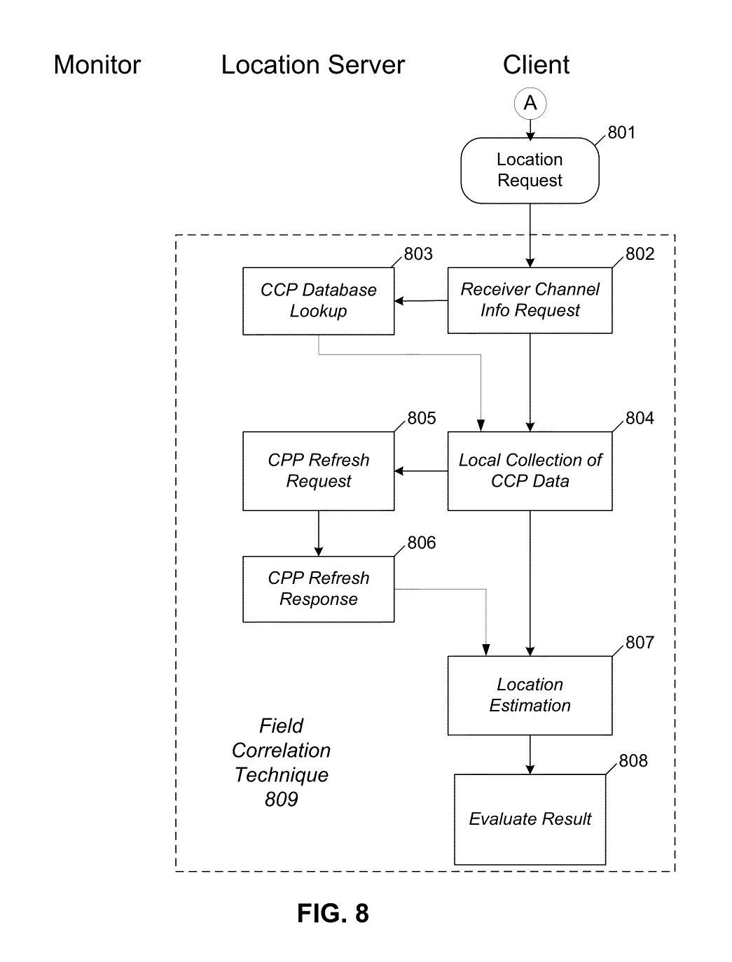

The client, acting has the local site, evaluates the channel information 504. The client, based on this evaluation may begin a Payload Correlation Procedure location (PCP) 513, a Field Correlation Procedure location (see FIG. 8), or both the PCP and FCP location in parallel or both the FCP and PCP in a 2-pass hybrid using the FCP followed by a PCP-based location if necessary. See FIG. 8 for details on the auxiliary Field Correlation Procedure location technique (“A”). If an PCP-based 513 location is selected, the client may then optionally downselect the DTV channels to be used from the initial candidate list. The downselection minimizes the need for data traffic, minimizes the measurement and calculation times and thus decreases the location latency. If a FCP-based location (“A”) is selected, see FIG. 8 for details.

The selection of DTV channels for use in the Payload Correlation Procedure 513 is based on the set DTV stations with an expected SNR higher than the threshold value or (in the case of an auxiliary location Field Correlation Procedure location attempt followed by a PCP-based location attempt) using DTV stations for which no TOA can be established using the auxiliary FCP Location [i.e. FIG. 8]. To minimize the effects of geometric-dilution-of-precision, channels may also be selected on the basis of transmitter location and geographic diversity. If several transmitters are located in proximity (a cluster), then their contribution to the location solution may be redundant and the members of the cluster may be discarded from the initial or subsequent (post FCP) channel list. Other factors in downselection include signal strength and signal-to-noise ratio either measured or predicted.

Implementing the Payload Correlation Procedure 513, the Client sends individual requests for payload on a per channel basis 503 to the Location Server, which forwards 504 each request to the Monitor Station for a remote capture of payload data. The Monitor Station then either recovers the most recent payload for the requested channel or tunes its DTV receiver to collect a new payload based on the request collection time period 508. The Monitor optionally compresses and/or demodulates the data to reduce required data transfer size. In one option, the received signal is demodulated, decoded using the trellis decoder, and then de-interleaved over several frames. From the resulting bit stream, a length corresponding to that in a field or a frame is transmitted for later reconstruction into a baseband signal. Once collected or recovered, the Monitor sends 509 the remote payload data for the current channel to the location server which forwards the remote Channel Field Payload to the Client 510. Meanwhile, the Client has captured a simultaneous local copy of the Payload Field as a reference 506. Once at the Client, the Payload and Reference are correlated 511 over the entire timespan of the capture interval and the time-difference-of-Arrival (TDOA) and the Frequency Difference of Arrival (FDOA) computed. Maximization of the gain using signal coherence in the cross-correlation operation may be obtained using the technique taught in U.S. Pat. No. 7,924,224, “Variable coherence integration for the location of weak signals”; LeFever et al, Apr. 12, 2011.

The remote and local capture and cross-correlation of channel data is continued until the channel list is exhausted 512. Using the computed location and any, the TOA and/or TOT data developed from the FCP procedure (FIG. 8), the original channel list, and the TDOA data from the payload correlation 513, a position and error estimate may then be computed 514.

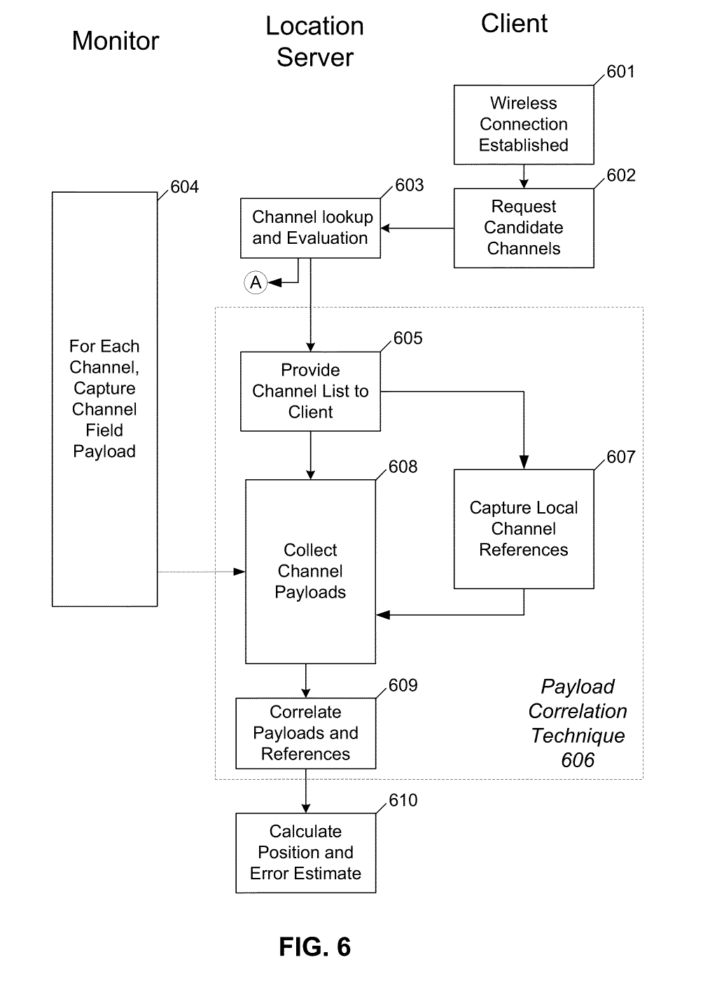

### FIG. 6—Server-Based Payload Correlation Implementation

FIG. 6 illustrates one of the possible alternative Payload Correlation technique implementations. Once the location operation is activated, a wireless connection 601 is established to move data between the local and remote sites. In this example implementation, the local site (where the payload and reference are correlated) is the Location Server while the Client serves as the remote site.

Once the wireless connection has been established, the client requests an initial set of candidate DTV transmitters 602. The request message contains either location information or a rough initial location either derived from the wireless communications system broadcasts.

The location server produces an initial list of DTV transmitters 603 based on the location information or rough location sent by the client. If a sufficiently low-latency, high bandwidth wireless communications exists between the Client and Location Server, the channel list may not be downselected or the downselection may be adjusted to remove few channels by allowing a lower SNR or redundancy in clustered transmitters.

This DTV initial candidate list is evaluated. In the evaluation, use of the auxiliary Field Location Procedure (“A”, see FIG. 8 for details) is considered based on the predicted signal power at the client. The auxiliary Field Correlation Procedure (FCP) may be considered as an alternative to the Payload Correlation Procedure 606, as a first pass in a multi-pass location with the PCP 606 or as a parallel location technique executing with the FCP 606.

The Monitor in this implementation of the Field Correlation Procedure 606 is continually streaming channel field payload data to the Location Server 604 over a low-latency, high bandwidth data link as collected. The collection may be in a pre-set sequential fashion or in parallel as the monitor receiver resources and data bandwidth allow. The Location Server caches the payload data 608 in modulo fashion, overwriting the prior local payload for a channel as new data is received.

The Client captures the remote copy of the channel payload and sends it to the Location Server 607. The Location Server cross-correlates the local and remote payload for each channel as the data becomes available 609, producing a TDOA, FDOA and error measurements. The Location Server then calculates 610 a position, velocity, confidence value and confidence area from the TOA, TDOA, FDOA and error values developed for the Client.

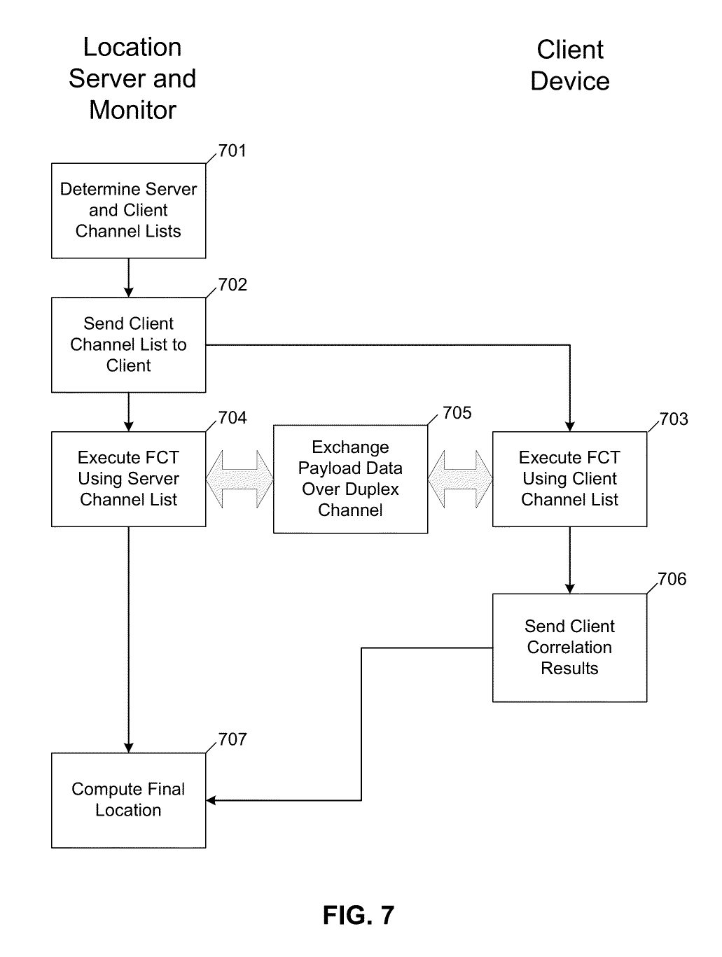

### FIG. 7—Duplex Communications

FIG. 7 details an improvement to the basic Field Correlation Procedure. In Time Division Duplex (TDD) or Frequency Division Duplex wireless communications systems a duplex link exists between the radio network and the mobile device. The duplex link allows concurrent if not simultaneous transmission of data in both the uplink and downlink directions.

In FIG. 7, the client device and location server/monitor are abstracted as local and remote. Nominally the remote site collects and delivers remote payload data while the local site sets the collection schedule, collects local payload data and performs the correlation processing of the local and remote payloads.

To make use of the bandwidth provided by the duplex link the candidate list is divided into two lists 701 (shown here as performed at the server, but could be done at the client or at a controller server—a designer's option). A client list will be provided to the client and a server list will be provided to the Location Server 702. Both the client and Location Server will act as the local site for their unique lists and as remote site for each other's list.

Consideration of the up and downlink capacities of the wireless communications link will be considered in the making of both lists.

The Location Server and Monitor will execute the Payload correlation technique 704, collecting local payload data and requesting remote payload data from the client as described in the list. The client will execute the Payload correlation technique 705, collecting local payload data and requesting remote payload data from the Location Server as described in the list. As an option, a master list with both the server and client list details and a tuning schedule may be provided to each site as to better schedule receiver resources.

Since the large data payloads and smaller payload request messages are being sent over both sides of the duplex wireless communications link 705, the bandwidth between the sites is maximized. Once the client channel list is exhausted, the client's correlation results 706 and the location server's correlation results are combined for a final location computation 707. Shown here as executed at the server for illustrative purposes, the actual final location computation can be either at the server or client.

### FIG. 8—Auxiliary FCP Location Technique

FIG. 8 illustrates the computation of a location using the Auxiliary (FCP-based) location technique. The Auxiliary Field Correlation Procedure location technique can be used in advance of the Payload Correlation Procedure (PCP), as an alternative to the PCP, or in parallel with the PCP.

In response to a location request 801, the Client requests predicted channel list 802 from the Location Server database 803. The predicted channel list contains the channel frequency, the transmitter location, and a cluster ID if the transmitter is part of a cluster of transmitters located in close proximity. The predicted channel list may also contain a predicted power level for each DTV transmitter.

Using the received channel list, the Client tunes its DTV receiver to collect radio signals 804. The Client then requests current channel parameter data 805 for only the DTV stations the Client can receive. The Location Server replies with an updated set of channel parameter data 806 as received from the monitor(s). Using the locally acquired channel parameter data and the received updated set of channel parameter data, the Client then performs a location estimate 807 using the TOA and TOT data. The technique for this auxiliary Field Correlation Procedure location determination using known signal components of DTV broadcast signals was taught in U.S. Pat. No. 6,861,984, “Position location using broadcast digital television signals,” Mar. 1, 2005.

Since the Client, and thus the WLS, has access to the WCN radio and control signals, a WCN-based location can be used to replace or supplement the DTV auxiliary location using cell-ID, cell-ID with ranging, or Enhanced Cell-ID. The Cell-ID technique uses the broadcast identification of the serving cell and serving sector that can be converted to a location estimate by simple translation to a pre-established latitude and longitude for the serving cell and/or sector as stored in the Location Server's WCN location database. The cell-ID with ranging technique uses the inclusion of the WCN-measured time or mobile-measured power based range estimate from the serving cell to the mobile position to refine the basic serving cell identifier based location estimate with minimal additional calculations.

A further refinement of the cell/sector identifier plus ranging method using the mobile-collected network information from one or more potential handover neighboring cells is generally known as Enhanced Cell-ID (ECID). The ECID technique relies on the mobile unit's ability to record the power levels from the beacons (also known as pilots) of multiple potential handover candidate/neighbor cells. This technique adds absolute power based and/or power-difference-of-arrival (PDOA) based measurements to improve the serving cell ranging location estimate. Another technique possible to refine the auxiliary Field Correlation Procedure based location can be found in U.S. Pat. No. 6,717,547, “Position location using broadcast television signals and mobile telephone signals,” Apr. 6, 2004.

The location estimate is then evaluated 808 to determine if an accuracy threshold has been reached. If reached or exceeded, the location result is sent to the requestor. If not met, then the Payload Correlation Procedure may be either started or the FCP-based location result saved and then combined for a hybrid FCP/PCP location estimate.

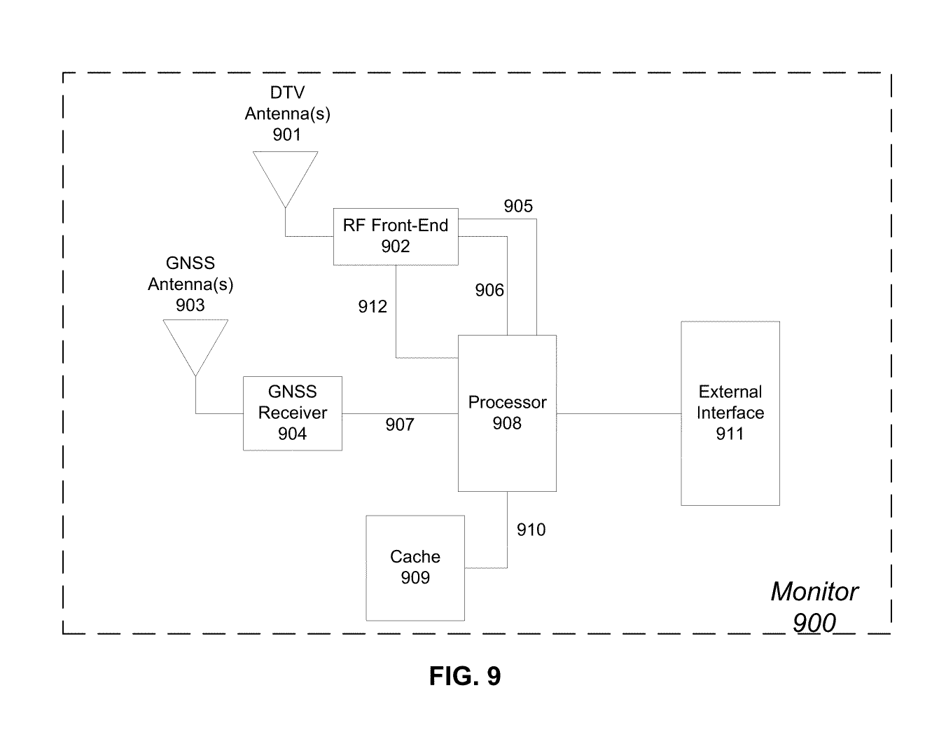

### FIG. 9—Example Monitor Station

FIG. 9 depicts an exemplary functional model of a Monitor 900. The Monitor 900 is a specialized DTV receiver under control of the Location Server. Possessing a single or multiple DTV antenna arrays 901, the Monitor can receive broadcast radio transmissions from the local DTV transmitters. In this example, the Monitor is configured to sequentially receive, digitize and store individual DTV transmissions, while in other implementations the monitor may process the individual DTV transmissions in parallel.

The Monitor has a GNSS antenna 903 allowing the GNSS receiver 904 to receive satellite broadcast radio signals. From these signals, the GNSS receiver can self-locate and supply the Processor with a highly precise clock signal to discipline the time and frequency references. The GNSS receiver 904 and Processor 908 communicate over a serial data bus 907 using an electrical and protocol standard such as NMEA 0183 or NMEA 2000.

The processor 908 selects the received channel and controls the RF front end 902 over a control link 912. The RF Front-End filters, downconverts, amplifies, and digitizes the received DTV radio signal from the DTV Antenna 901 into an In-phase (I) bit stream 905 and a Quadrature (Q) bit stream 906 that are then passed to the Processor 808.

For each received DTV channel, the Processor 908 computes the frequency Offset of pilot channel (PFO) and the duration of frame versus ideal (FCRO). Using the time of arrival (TOA) of the frame and the known transmitter location, it computes a Time-of-Transmission (ToT). The Processor 908 packages these values into a single Channel Clock Parameters (CCP) message per received DTV channel. The CCP message is sent to the Location Server continuously as available. The Processor 908 also separates out the pilot, the Field Synchronization and the segment Synchronization signals.

Using the best (strongest or most likely to be received with good quality by any Client in the area) DTV signal, the Processor 908 computes a Frame Synchronization package. The Frame Synchronization package includes the frame start time and the contents of the segment immediately following the Frame Synchronization segment. This Frame Synchronization Package is computed continuously. An extended Frame Synchronization package may be prepared using two or more channels based on the DTV signals reliably received by the Client(s).

The Processor 908 using the received GNSS signal information prepares and periodically updates a GNSS Assistance package for delivery via the External Interface 811 to the Location Server. The External Interface 911 may connect the Monitor 900 to a wired or wireless backhaul to the Location Server. See commonly-owned U.S. Pat. No. 6,727,847, “Using digital television broadcast signals to provide GPS aiding information,” Apr. 27, 2004, for more details on GNSS assistance.

For each DTV radio signal, the Processor 908 captures and caches a complete digitized field and caches it for later use. In this example, the Cache 909 is shown as an external memory facility connected to the Processor by a high-speed data bus 910. Other implementations of the caching storage include on-chip memory connected by address and data buses. The field data may be manipulated prior to caching to reduce its size. (Any lossless data compression technique would be suitable to reduce the size of the data packets transferred from the Monitor to the Server, and then on to the Client.) This capture and cache operation is continuous, with new data overwriting the old. Upon request from the Location Server, the Processor 908 will recover cached data for the specified channels, aggregate the data then include the data in a response message via the external interface 911.

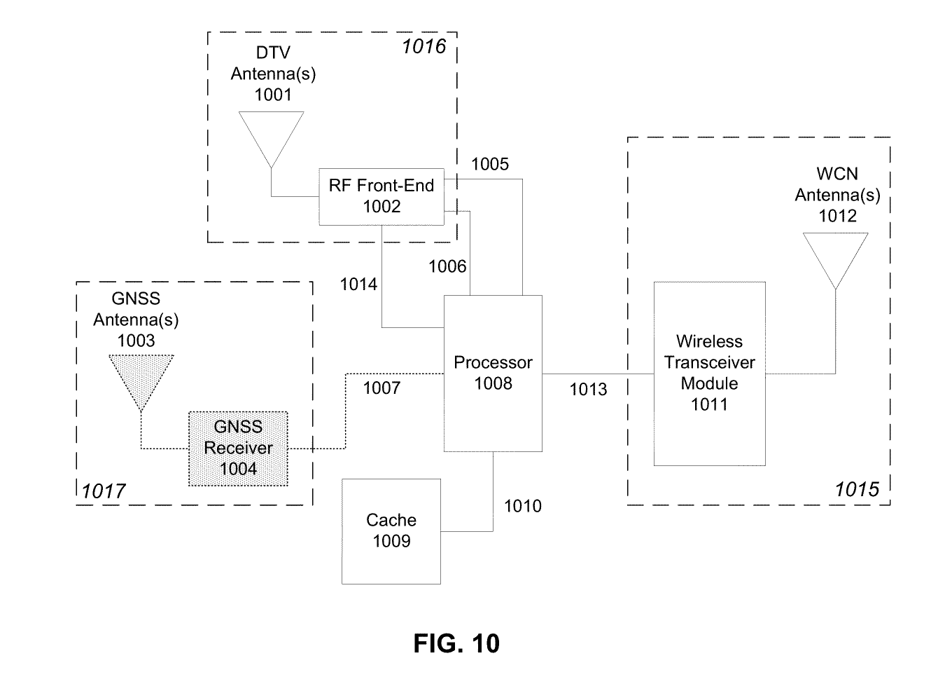

### FIG. 10—Example Client Receiver

FIG. 10 depicts an exemplary functional model of a Client. The Client is a specialized DTV receiver under control of the user or Location Server. Possessing a single DTV antenna array 1001, the Client can receive broadcast radio transmissions from the local DTV transmitters. In this example, the Client is configured to receive, digitize and process individual DTV transmissions in sequence, while in other implementations the Client may process the individual DTV transmissions in parallel.

The Client may have an optional GNSS antenna 1003 allowing the GNSS receiver to receive satellite broadcast radio signals. From these signals, the GNSS receiver can self-locate and supply the Client's Processor with a highly precise clock signal to discipline the time and frequency references. The GNSS receiver 1004 and Processor 1008 communicate over a serial data bus 1007 using an electrical and protocol standard such as NMEA 0183 or NMEA 2000. If the Client is equipped with a GNSS module 1017 (a GNSS antenna 1003 and receiver 1004), the Processor 1008 will manage the GNSS data as it is pushed over the GNSS interface 1007. The Processor 1008 would then also be responsible for implementation of the Assisted GNSS algorithms using the locally received GNSS signals and the Assistance Data delivered over-the-air to the Wireless Module 1015.

The local Wireless Communications Network (WCN) is used to communicate between the Client and Location Server. The Client's Wireless subsystem 1015 (WCN antenna 1012 and WCN transceiver 1011) allows 2-way radio communication with the local WCN. The WCN subsystem 1015 also provides the Processor 1008 with WCN broadcast information including parameters (e.g., base station ID, Cell-Global-Identifier, Physical cell-ID, cell-ID, cell/sector-ID, service set identifier (SSID), Location Area Code, Routing Area Code).

Rather than continuously scanning for local DTV channels, the Client stays in a sleep mode until tasked by a location request from the Location Server via the External interface 1013 or by the user (e.g. a mobile device-based application). Using a list of possible DTV channels the processor 1008 tunes, via control data link 1014, the RF Front-End 1002. The RF Front-End serves to filter, downconvert, amplify, and digitize the received DTV radio signal from the DTV Antenna 1001 into an In-phase (I) bit stream 1005 and a Quadrature (Q) bit stream 1006 that are then passed to the Processor 1008.

The processor 1008 runs the software necessary for the cross-correlation process, calculation of times-of-arrival, calculation of the times-of-transmission, the downselection of channels, the tuning of the DTV receiver RF Front-end 1002, the interface with the Wireless module 1015, and the management of the short term storage of the cache 1009 (shown in this example as part of the processor 1008 chipset and connected by address and data buses 1010). The processor 1008 may also, dependent on the deployment option, be used to calculate the final position of the Client (Client-based processing) or may transmit, using the wireless module 1011, channel information to the Location Server for location calculation there.

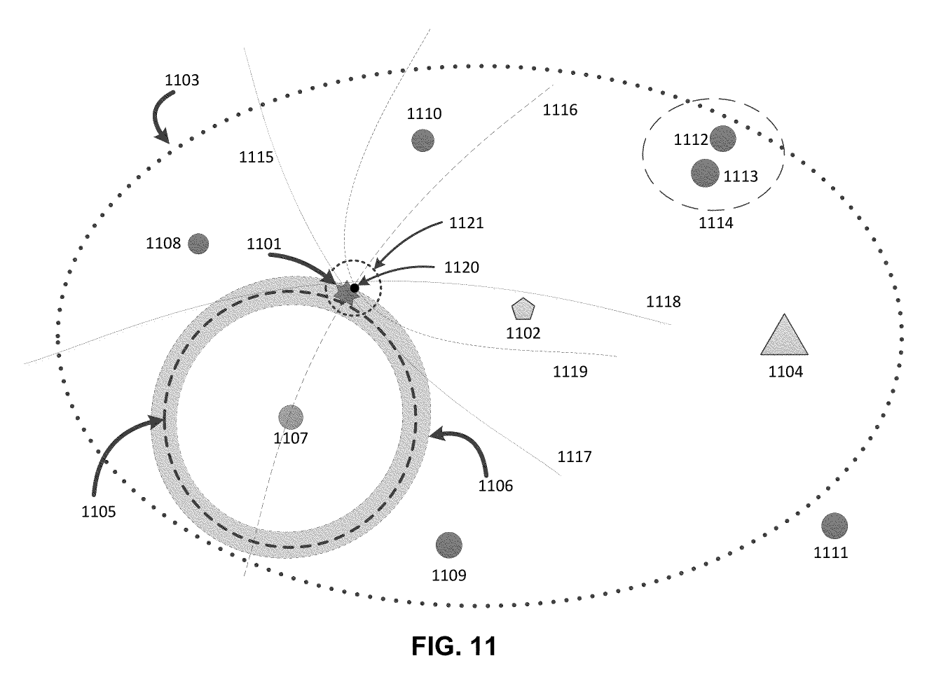

### FIG. 11—Final Location Calculation

FIG. 11 depicts a final location calculation. For the purposes of illustration a two-pass location operation is depicted with a first pass using the auxiliary Field Correlation Procedure and a second pass using the more sensitive Payload Correlation Procedure. The wireless communications network (WCN) and location information derived from the WCN is not shown for purposes of clarity.

The Client 1101 is in the service area 1103 of a monitor 1102 with is under control of a Location Server 1104. Based on the reported wireless communications network information, an initial candidate list was selected and from the information included in this list, a 2-pass location option was selected. In the first-pass, using the auxiliary FCP location technique, only radio signals from a single DTV transmitter 1107 could be used to generate a time-of-arrival location 1013 for the Client 1101. The TOA circle 1105 is shown here with error margin 1106.

Using the Payload Field Correlation technique as the second pass, DTV transmitters 1107 1108 1109 1110 1111 1112 1113 are considered due to presence in the monitored service area 1103 or from signal levels detected by the Client 1101. The optional channel downselect stage removes DTV transmitters from consideration due factors such as signal strength, predicted poor geometry from the existence of a co-sited transmitter 1112 1113 in a cluster 1114, predicted distance 1111, or historical information obtained from previous locations in the service area 1103. The elimination of improbable, poorly sited or redundant transmitters serves to reduce the required transmissions of payload data and minimize location latency in the payload correlation technique.

The downselected DTV transmitter list 1107 1108 1109 1110 1113 is then used to schedule receiver tuning, order the collection of signals at the Client and monitor, and then set up for the correlation of the collected signals. Cross-correlations above the floor threshold are used in the final location and velocity solution, shown here as the resulting in time-difference-of-arrival (and frequency-difference-of-arrival) hyperbolas 1115 1116 1117 1118 1119 and the TOA 1105 from the auxiliary location technique. The floor threshold is set based on a predicted value or from data on test locations in the service area 1103.

Combining the TDOA results 1115 1116 1117 1118 1119, location information derived from the wireless connection, and any FCP-produced TOA data 1104 produces a location estimate 1120 and error estimate (shown here as an ellipse) 1121. Velocity (not shown) of the client is also produced as a result combined TDOA/FDOA operation using the correlation data.

The use of the payload correlation technique may be iterative, that is, a final location with computed error above an accuracy threshold need not be final. Subsequent iteration of the payload correlation technique may be accomplished with the any removed or downselected DTV transmitters added back into the transmitter list and then restarting.

### FIG. 12—Signal Extraction Points

While FIGS. 9 and 10 both depict example receivers, a vast array of alternative receiver designs could be used in DTV location. The design of these receivers is based in large measure on the designer's choice of signal extraction points. FIG. 12 shows a representative ATSC DTV receiver chain 1201. The first potential collection point, the RF Collection Point 1209 is immediately after the receiver antennae 1202 and offers the ability to sample the radio signal directly using analog-to-digital conversion. Use of this collection point is most likely to occur in purely software defined radios (SDRs).

The Baseband Collection Point 1210 immediately after the RF downconverter allows signal collection at lower frequencies and after radio signal conditioning (bandpass filtering and amplification). Use of this collection point allows the simplest receiver architecture, but produces large amounts of data and inevitably be a noisier signal due to lack of processing gain.

The Demodulated Collection Point 1211, immediately after the VSB (for ATSC) Demodulator 1204 allows collection of the signal as a bit stream. Data acquired at this point will be both cleaner in terms of noise and reduced in terms of data size from the upstream (to the left) collection points. The disadvantage of using the Demodulated Collection Point 1211 is the need to re-modulate the signal before correlation processing may begin.

The Decoded Frame Collection Point 1212 immediately after the Trellis Decoder 1206 allows collection of the signal as an expanded bit stream as the every two transmitted bits are decoded into three bits. Use of this site allows a further reduction in data size (due to the removal of redundant information and the pilot and synchronization signals). Noise is further eliminated by use of Forward Error Control. The disadvantages are the need to re-code, re-add the pilot and synch, and re-modulate to baseband before correlation processing.

The Decoded Multi-Frame Collection point 1213 is sited on the output of the Reed-Solomon (RS) Decoder. The Decoded Multi-Frame Collection point 1213 features a bit stream where the trellis decoded expanded bit stream has been de-interleaved and subjected to Forward Error Correction. Data for extraction has been reduced to a minimum at this point. This access point also allows access to multi-frame signals such as the ATSC Mobile DTV standard ATSC-M/H (A/153). The disadvantage of collection of signal at this point is the need for an almost complete DTV transmitter chain to convert the signal back to baseband prior to correlation processing. The collected signal will require recoding using the Reed-Solomon encoder, re-interleaving, re-coding with the Trellis encoder, addition on the pilot and synchronization signals, and re-modulation to baseband.

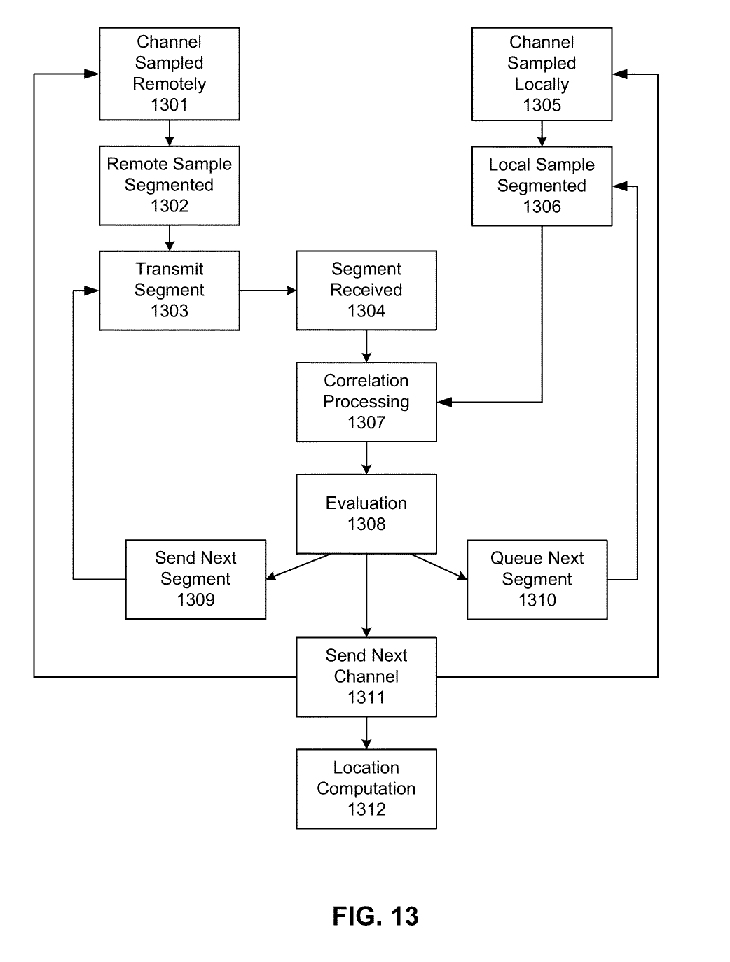

### FIG. 13—Incremental Correlation

Due to the large DTV bandwidth, the smaller wireless communications link bandwidth, and the desire for a low-latency location estimate, an incremental correlation operation may be used to reduce the amount of DTV signal data needed to be transmitted over the wireless communications link. The concept of incremental correlation functions in both a server-based or client-based signal collection or location calculation. In FIG. 13, either the client or server may be the remote or local entity.

After the channel list has been established and delivered and the local and remote receivers selected, scheduled and tuned, the remote entity samples a DTV channel's signal 1301 at the selected collection point (see FIG. 12 for signal collection points) while simultaneously the local entity does the same 1305.

The local entity then segments the local sample into pre-defined segments 1306 while the remotely collected samples are also divided into segments 1302 and then transmitted to the local entity 1303. Once received by the local entity 1304, the remote segment is correlated with the local segment to form a correlation signal 1307. The correlation signal is added to any existing correlation signal for the DTV channel and then evaluated 1308 against a pre-determined threshold. This threshold may be either a default value set to prevent false positives or tailored to the service area using propagation models or field test locations. If the correlation signal does not exceed the threshold, then the remote entity is commanded to send the next remote segment 1309 while the local entity queues the next local segment 1310. If the correlations signal does exceed the threshold, or if no more segments are available, then the local and remote entities are commanded 1311 to being delivering samples from the next DTV channel in the channel list. Once all channels in the channel list are exhausted, then the location computation can be performed using the computed correlation signals in a time-difference-of-arrival computation.

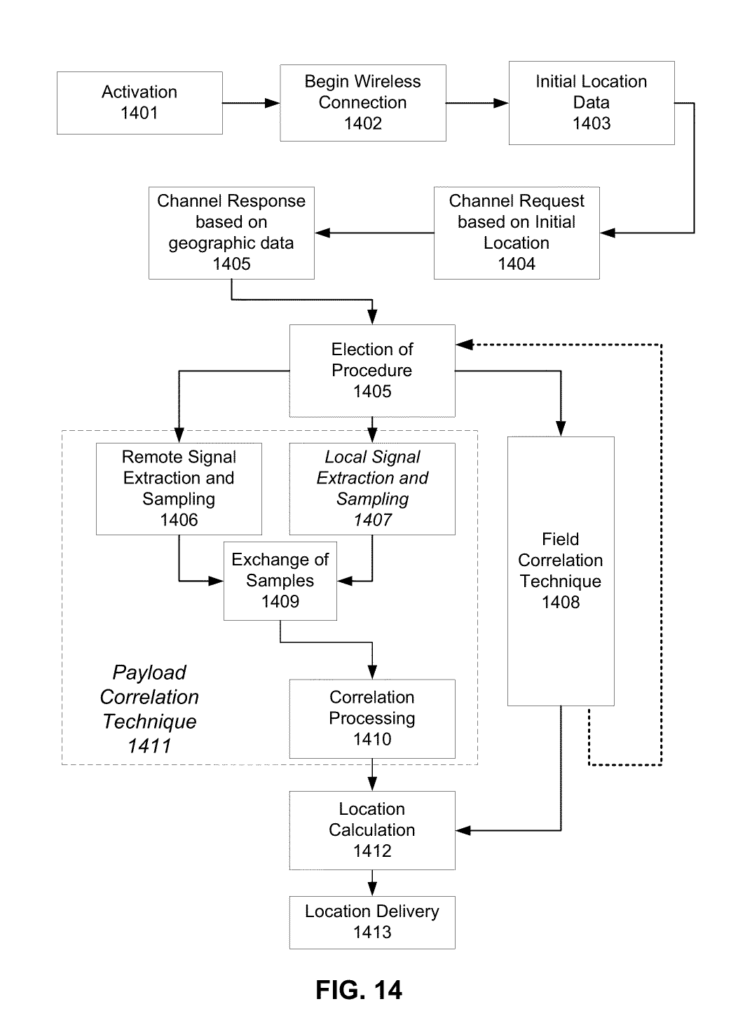

### FIG. 14

FIG. 14 shows a high level functional flow for the present invention. The location attempt always starts with Activation 1401, which may begin at the Location Server in response to a network-initiated location or on the client device in response to an on-board application or a user input. Once initiated, the wireless connection is established 1402. The details for starting a wireless connection between the location server and the client device vary from wireless network to network but are well-known and functionally transparent. The need for client device collection of initial location data 1403 is for determination of the initial DTV channel list. The initial location data will be gleaned from the wireless communication system's broadcast information which can be received by the client device. The Channel Request message includes the initial location data or in the case where the client has previously been informed of the geographic mapping of wireless communications broadcast sites (e.g. cell sites, access points) the initial location estimate 1404. The channel response message 1405 contains the initial channel list. The initial channel list includes the identity, frequencies, and DTV antenna geographic locations estimated to be hearable by the client device's DTV receiver. The channel response message 1405 may also contain predicted power levels for each DTV transmitter in the initial channel list and/or an estimate of the uplink and downlink bandwidth allowed by the wireless communications channel.

Once the client has the initial channel list it may downselect from that list or setup special location handling in an election of procedure 1405. Special handling includes selection of Auxiliary Field Correlation Procedure location procedure 1408 (as detailed in FIG. 8) an independent location means, selection of FCP 1408 as a first location means in a multi-pass location procedure, or execution of an FCP-based location 1408 in parallel to the Payload Correlation Procedure 1411.

Election of the Payload Correlation Procedure (PCP) 1411 may include either the Location Server (with Monitor(s)) as the remote or local site with the client device serving as the opposite (remote/local) site. Once the remote and local receiver sites are tasked they begin the extraction and sampling of the DTV channel. The tasking operation can include selection of the remote and local sites, evaluation of the simplex or duplex signal bandwidth, creation of the channel lists, ordering of the channel lists, distribution of the channel lists, and setting of detection threshold values. The sending of samples 1409 between the local and remote is dependent on the wireless communications network bandwidth—the sampled DTV signals may be transmitted to the local site for correlation processing or samples may be exchanged for correlation processing 1410. The expected available bandwidth communications link between the local and remote sites can be matched with signal collection point within the receiver (see FIG. 12) to produce the lowest latency location (a collection point would have been designed into the receiver specialized for a particular communications system). Whole samples or segments of samples may be sent. The Payload Correlation Procedure 1411 is iterative, repeating until the channel list is exhausted.

The calculation of the final location estimate 1412 may be performed at either the local or remote site (i.e. either at the Location Server or the Client device). The location calculation may include of all location-related information developed since activation 1401. The wireless communications network derived initial location, any auxiliary FCP location 1408 and the time-differences from Payload Correlation technique 1411 may all contribute to the final location estimate. Once a location estimate has been computed, the location may then be delivered 1413 to the requestor (or a destination specified by the requestor).

### Alternative Embodiments

### DVB (Europe)

Radio Location using Digital Video Broadcasting (DVB) was disclosed in U.S. Patent Application Ser. No. 60/281,269, entitled “Use of the ETSJ DVB Terrestrial Digital TV Broadcast Signals for High Accuracy Position Location in Mobile Radio Links,” by James J. Spilker, filed Apr. 3, 2001. The European Telecommunications Standards Institute (ETSI) defined Digital Video Broadcasting (DVB) standards including DVB-T, DVB-T2, DVB-H and DVB-SH. The Payload Correlation Procedure is applicable to the DVB standards. While previous techniques taught for the location of DVB receivers used known sequences in the transmission, such as the scattered pilot carrier signals embedded within the DVB signal, the payload correlation technique uses both the known and a priori unknown signal components (e.g. the MPEG or other encoded video payload).

### ISDB-T (Japan)

The Payload correlation technique is also applicable to DTV signals as defined by the Japanese Integrated Service Digital Broadcasting-Terrestrial (ISDB-T) and the mobile variants “1seg” and “Oneseg2”. While previous techniques taught for the location of ISDB receivers used known sequences in the transmission such as the scattered pilot carrier signals embedded within the DVB signal, the payload correlation technique uses both the known and a priori unknown signal components (e.g. the MPEG, AVS or other encoded video payload).

### DTMB (China)

DTMB (Digital Terrestrial Multimedia Broadcast), formerly DMB-T/H (Digital Multimedia Broadcast-Terrestrial/Handheld), is another digital video system where the payload correlation technique can be used to position DTV receivers. By using the known and a priori unknown signal components (e.g. the MPEG or other encoded video payload), DTMB receivers can be located.

### Digital Audio

As disclosed in U.S. Pat. No. 7,042,396, “Position location using digital audio broadcast signals,” May 9, 2006, potentially more accurate and higher yield positioning of digital audio broadcast (e.g. DAB, DAB+ and DMB) receivers can be accomplished using the payload correlation technique. By using the known and a priori unknown signal components (e.g. the MPEG, ACC+, WMV6, or other encoded audio payload), digital audio broadcast receivers can be located.

### CMMB (China—Mobile DTV)

As disclosed in China Patent Application No. 201110112741.5, “POSITION, TIME AND FREQUENCY DETERMINATION USING CHINA MOBILE MULTIMEDIA BROADCASTING SIGNALS,” the location of mobile or tethered wireless devices using China Mobile Multimedia Broadcasting (CMMB) can be improved using the payload correlation technique on the terrestrial signal that contains both known and a priori unknown signal components of the OFDM broadcast signal.

### ATSC M/H

An approach for positioning of Advanced Television Systems Committee Mobile/Handheld (ATSC-M/H) receivers is disclosed by U.S. Pat. No. 7,737,893, “Positioning in a single-frequency network,” Jun. 15, 2010. In a single-frequency network (SFN) such as ATSC-M/H, geographically dispersed transmitters emit time-synchronized replica signals to be received by mobile/handheld devices. Use of the payload correlation technique allow for more precise and higher yield receiver location.

### Future ATSC Compatibility

The payload correlation technique is independent of the ATSC standard and will require only software re-configuration to support ATSC 2.0 while ATSC 3.0 may require changes to the RF front-end before the payload correlation technique can be used for location purposes. The ATSC 2.0 standard, expected mid-2013, is being drafted to include non-real-time file based content delivery, allowing for caching of programs and other data. ATSC 2.0 will also include Advanced Video Coding (AVC) to replace the current MPEG video coding and the addition of Digital Rights Management (DRM) granting conditional access capability to ATSC DTV, which will allow for subscription content in terrestrial broadcasts and enhance audience measurement capability. While ATSC 2.0 is seen as a major evolutionary step for services, ATSC 2.0 will be backwards compatible with ATSC 1.0 since changes are limited to the transport, management and application layers of the DTV system.

### Hybrid Positioning

DTV positioning, timing and frequency determination may also be hybridized with location-related information from the cellular network, location information from network-based TDOA and/or AOA based wireless location systems or with information determined from navigation signals, such as those from the Naystar GPS, Beidou, GLONASS, Galileo, and the like. For instance, if a first computation of a final location fails to meet an imposed accuracy threshold, then a second computation using both the DTV and other wireless location or navigation signals may be attempted if the location latency allows and the location services requirements so allow and demand.

### CONCLUSION

The true scope the present invention is not limited to the presently preferred embodiments disclosed herein. For example, the foregoing disclosure of a presently preferred embodiment of a Wireless Location System uses explanatory terms, such as Client, Monitor, Wireless Location System, Location Server, Portable Pseudo-television transmitter, Monitor Interconnection Facility and the like, which should not be construed so as to limit the scope of protection of the following claims, or to otherwise imply that the inventive aspects of the Wireless Location System are limited to the particular methods and apparatus disclosed. Moreover, as will be understood by those skilled in the art, many of the inventive aspects disclosed herein may be applied in location systems that use other terrestrial broadcast signals. For example, the invention is not limited to systems employing the Wireless Location System as constructed as described above. The Monitor, Client, etc., are, in essence, programmable radio, data collection, and processing devices that could take a variety of forms without departing from the inventive concepts disclosed herein. Given the rapidly declining cost of digital signal processing and other processing functions, it is easily possible, for example, to transfer the processing for a particular function from one of the functional elements, such as the Location Server, described herein to another functional element (such as the Monitor) without changing the inventive operation of the system. In many cases, the place of implementation (i.e., the functional element) described herein is merely a designer's preference and not a hard requirement. Accordingly, except as they may be expressly so limited, the scope of protection of the following claims is not intended to be limited to the specific embodiments described above.

We claim:

1. A method for determining the position of a Client terminal, comprising:
(a) receiving at a Client terminal and Monitor Station a plurality of digital television (DTV) signals, wherein each DTV signal is broadcast from a DTV transmitter;
(b) determining pseudo-ranges between the Client terminal and a plurality of DTV transmitters using a payload correlation procedure (PCP) and a priori unknown portions of the received DTV signals, wherein the PCP comprises sampling the DTV signals at local and remote entities, wherein the Client terminal comprises one of the local and remote entities, and correlating signal data derived at the remote entity with signal data derived at the local entity; and
(c) determining a position of the Client terminal based on the pseudo-ranges and a geographic location of each of the plurality of DTV transmitters and the Monitor Station.

2. The method of claim 1, wherein the Client terminal is the local entity and acts as a reference.

3. The method of claim 1, wherein the Client terminal is the remote entity and a server or the Monitor Station acts as a reference.

4. The method of claim 1, wherein the payload correlation procedure is performed in combination with a field correlation procedure (FCP).

5. The method of claim 4, wherein the PCP is performed after the FCP is attempted.

6. The method of claim 4, wherein the PCP is performed in parallel with the FCP.

7. The method of claim 1, wherein the PCP further comprises:
at a selected signal extraction point of the remote entity, sampling a DTV channel's signal;
at the local entity, simultaneously sampling the DTV channel's signal;
at the local entity, dividing the local sample data into segments;
at the remote entity, dividing the remote sample data into segments;
transmitting a remote data segment from the remote entity to the local entity;
at the local entity, correlating the remote segment with a local segment to form a correlation signal; and
at the local entity, adding the correlation signal to any existing correlation signal for the DTV channel to form a sum of correlation signals.

8. The method of claim 7, wherein, once all channels in a channel list are exhausted, then a location computation is performed using the computed correlation signals.

9. The method of claim 7, wherein the PCP further comprises:
at the local entity, comparing the sum of correlation signals to a pre-determined threshold;
if the correlation signal does not exceed the threshold, then causing the remote entity to send another remote segment to the local entity; and
if the correlation signal exceeds the threshold, then the local and remote entities are commanded to deliver samples from the next DTV channel in the channel list.

10. The method of claim 4, wherein the FCP comprises:
the Client terminal requests a predicted channel list from a Location Server, wherein the predicted channel list contains a channel frequency and transmitter location;
using a received channel list, the Client terminal tunes a DTV receiver to collect DTV signals;
the Client terminal requests current Channel Parameter data from the Location Server for the DTV stations the Client can receive;
the Location Server replies to the Client terminal with an updated set of channel parameter data as received from the Monitor Station; and
using the channel parameter data, the Client terminal computes a location estimate using time of arrival (TOA) and time of transmission (TOT) data.

11. The method of claim 10, wherein the predicted channel list further comprises a cluster ID for a transmitter that is part of a cluster of transmitters located in close proximity.

12. The method of claim 1, further comprising the step, performed by the Location Server, of refining the location estimate using at least one of a cell-ID, cell-ID with ranging, or Enhanced Cell-ID location procedure.

13. The method of claim 1, further comprising the step of performing a mobile-based location procedure to determine a coarse Client terminal location estimation, and using said coarse Client terminal location estimation for initial DTV channel selection.

14. The method of claim 13, wherein the mobile-based location procedure comprises one of Cell-ID, Cell-ID with power-based ranging, Cell-ID with time-based ranging, and radio frequency fingerprinting or Enhanced Cell-ID (ECID).

15. The method of claim 1, further comprising limiting a number of payloads to be transmitted by downselection of DTV channels from an initial channel list using power and/or geographic information concerning the DTV transmitters.

16. The method of claim 1, further comprising communicating the signal data between the remote and local entities using duplex communications links and performing correlation at both the local and remote entities.

17. The method of claim 1, further comprising selection of signal extraction points at the local and remote entities in accordance with desired payload size, receiver complexity, and post-processing load.

18. The method of claim 1, wherein DTV signal reception at the Monitor Station is performed as tasked by a Location Server.

19. The method of claim 1, wherein DTV signal reception at the Monitor Station is performed on a periodic basis.

20. A system for determining the position of a Client terminal, comprising:
a Client terminal and a Monitor Station each of which is configured to receive a plurality of digital television (DTV) signals, wherein each DTV signal is broadcast from a DTV transmitter;
a processor configured to determine pseudo-ranges between the Client terminal and a plurality of DTV transmitters using a payload correlation procedure (PCP) and a priori unknown portions of the received DTV signals, wherein the PCP comprises sampling the DTV signals at local and remote entities, wherein the Client terminal comprises one of the local and remote entities, and correlating signal data derived at the remote entity with signal data derived at the local entity; and
a processor configured to determine a position of the Client terminal based on the pseudo-ranges and a geographic location of each of the plurality of DTV transmitters and the Monitor Station.

21. The system of claim 20, wherein the Client terminal is the local entity and acts as a reference.

22. The system of claim 20, wherein the Client terminal is the remote entity and a server or the Monitor Station acts as a reference.

23. The system of claim 20, wherein the payload correlation procedure is performed in combination with a field correlation procedure (FCP).

24. The system of claim 23, wherein the PCP is performed after the FCP is attempted.

25. The system of claim 23, wherein the PCP is performed in parallel with the FCP.

26. The system of claim 20, wherein the PCP further comprises:
at a selected signal extraction point of the remote entity, sampling a DTV channel's signal;
at the local entity, simultaneously sampling the DTV channel's signal;
at the local entity, dividing the local sample data into segments;
at the remote entity, dividing the remote sample data into segments;
transmitting a remote data segment from the remote entity to the local entity;
at the local entity, correlating the remote segment with a local segment to form a correlation signal; and
at the local entity, adding the correlation signal to any existing correlation signal for the DTV channel to form a sum of correlation signals.

27. The system of claim 26, wherein, once all channels in a channel list are exhausted, then a location computation is performed using the computed correlation signals.

28. The system of claim 26, wherein the PCP further comprises:
at the local entity, comparing the sum of correlation signals to a pre-determined threshold;
if the correlation signal does not exceed the threshold, then causing the remote entity to send another remote segment to the local entity; and
if the correlation signal exceeds the threshold, then the local and remote entities are commanded to deliver samples from the next DTV channel in the channel list.

29. The system of claim 23, wherein the FCP comprises:
the Client terminal requests a predicted channel list from a Location Server, wherein the predicted channel list contains a channel frequency and transmitter location;
using a received channel list, the Client terminal tunes a DTV receiver to collect DTV signals;
the Client terminal requests current Channel Parameter data from the Location Server for the DTV stations the Client can receive;
the Location Server replies to the Client terminal with an updated set of channel parameter data as received from the Monitor Station; and
using the channel parameter data, the Client terminal computes a location estimate using time of arrival (TOA) and time of transmission (TOT) data.

30. The system of claim 29, wherein the predicted channel list further comprises a cluster ID for a transmitter that is part of a cluster of transmitters located in close proximity.

31. The system of claim 20, wherein the Location Server is configured to refine the location estimate using at least one of a cell-ID, cell-ID with ranging, or Enhanced Cell-ID location procedure.

32. The system of claim 20, further comprising a processor configured to perform a mobile-based location procedure to determine a coarse Client terminal location estimation, and using said coarse Client terminal location estimation for initial DTV channel selection.

33. The system of claim 32, wherein the mobile-based location procedure comprises one of Cell-ID, Cell-ID with power-based ranging, Cell-ID with time-based ranging, and radio frequency fingerprinting or Enhanced Cell-ID (ECID).

34. The system of claim 20, further comprising means for limiting a number of payloads to be transmitted by downselection of DTV channels from an initial channel list using power and/or geographic information concerning the DTV transmitters.

35. The system of claim 20, further comprising means for communicating the signal data between the remote and local entities using duplex communications links and performing correlation at both the local and remote entities.

36. The system of claim 20, further comprising means for selecting signal extraction points at the local and remote entities in accordance with desired payload size, receiver complexity, and post-processing load.

37. The system of claim 20, wherein DTV signal reception at the Monitor Station is performed as tasked by a Location Server.

38. The system of claim 20, wherein DTV signal reception at the Monitor Station is performed on a periodic basis.
